(19) United States
(12) Patent Application Publication
(10) Pub. No.: US 2015/0298574 A1
(43) Pub. Date: Oct. 22, 2015

(54) DUAL MOTOR ELECTRIC VEHICLE DRIVE WITH EFFICIENCY-OPTIMIZED POWER SHARING

(71) Applicant: FORD GLOBAL TECHNOLOGIES, LLC, Dearborn, MI (US)

(72) Inventor: Eric D. Bramson, Ann Arbor, MI (US)

(73) Assignee: FORD GLOBAL TECHNOLOGIES, LLC, Dearborn, MI (US)

(21) Appl. No.: 14/254,131

(22) Filed: Apr. 16, 2014

(51) Int. Cl. B60L 15/20

(52) U.S. Cl. CPC B60L 15/20; B60L 2240/423

(57) ABSTRACT

An electric vehicle drive has a first motor/generator, a second motor/generator, and a set of wheels. A gear set couples the first and second motor/generators to the set of wheels such that a total wheel torque is selectably divided between the first and second motor/generators. A torque calculator responds to an operator speed input to select a total torque target. A torque allocator substantially maximizes a combined efficiency of the first and second motor/generators by dividing the total torque target into first and second torque targets for the first and second motor/generators according to a ratio selected in response to an instantaneous motor/generator speed and the total torque target.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to electric vehicle drives, and, more specifically, to using a plurality of traction motor/generators to share torque in a manner that optimizes overall efficiency.

The electric traction motor of an electric vehicle has an efficiency that varies with speed and torque. For example, a motor that is operating at very high or very low torque may have reduced efficiency compared with the same motor operating at an in-between level of torque. Although the motor has been designed to optimize average efficiency over an expected operating range, there remain operating points for which the motor efficiency is well below its peak. Operation in these reduced-efficiency regions consumes more energy than would be consumed if the motor were operating at its peak efficiency, thus reducing the driving range obtainable on a particular battery charge.

It is known to keep the motor operating closer to its efficiency peak by using a multi-speed gearbox to transmit all of the power from the motor to the wheels. This solution, familiar for its use with IC engines, comes with penalties in size, weight, cost, and a degradation in powertrain smoothness. It is possible to use a continuously-variable gearbox to avoid compromising powertrain smoothness, but this also comes at higher cost.

It would be desirable to keep a motor/generator of an electric vehicle operating closer to its peak-efficiency point without incurring the penalties mentioned above.

### SUMMARY OF THE INVENTION

In one aspect of the invention, an electric vehicle drive comprises a first motor/generator, a second motor/generator, and a set of wheels. A gear set couples the first and second motor/generators to the set of wheels such that a total wheel torque is selectably divided between the first and second motor/generators. A torque calculator responds to an operator speed input to select a total torque target. A torque allocator substantially maximizes a combined efficiency of the first and second motor/generators by dividing the total torque target into first and second torque targets for the first and second motor/generators according to a ratio selected in response to an instantaneous motor/generator speed and the total torque target.

### BRIEF DESCRIPTION OF THE DRAWINGS

FIG. 1 is a block diagram showing a vehicle having an electric drive according to one preferred embodiment of the invention.

FIG. 2 is a block diagram showing one embodiment of preferred control circuits for the invention.

FIG. 3 is a graph showing how efficiency of a traction motor changes with rotation speed and torque output.

FIG. 4 is a graph comparing variable efficiency with changing torque output for two individual traction motors and the motors working together to deliver the torque output.

FIG. 5 is a graph plotting overall efficiency with changes in total torque, wherein separate plots correspond to different relative torque contributions of the individual motors.

FIG. 6 is a graph comparing the efficiency of one motor alone with an optimized efficiency obtained when allocating the total torque proportionally between two motors.

FIG. 7 is a diagram showing the derivation of aggregate motor losses from the individual losses of the motors for a particular rotation speed.

FIG. 8 is a diagram showing combined motor efficiencies for various combinations of torque contribution from the individual motors.

FIG. 9 is a diagram showing one preferred example of a lookup table for allocating the division of torque in the present invention.

FIG. 10 is a flowchart showing one preferred method of the invention.

### DETAILED DESCRIPTION OF PREFERRED EMBODIMENTS

The present invention uses two (or more) electric motor/generators in an electric vehicle drive to convert between stored electrical energy and vehicle propulsion. Although the invention will be described in the context of motor operation to propel the vehicle using the plurality of motor/generators together, it applies equally to operation as generators during regenerative braking to increase the overall efficiency for converting momentum of the vehicle into stored electricity.

By using two electric motors connected in parallel to a vehicle's wheels such that the torque from each motor is summed at the wheels, the invention shares the required torque between the two motors. In a given operating condition, an otherwise heavily-loaded motor can thus be run in a more lightly-loaded condition with the contribution of another motor also running in a lightly-loaded condition. Furthermore, at every operating point, the relative torque contributions are adjusted to provide an amount of torque from each motor that achieves the highest available system efficiency.

Because the invention uses a second motor to contribute only part of the wheel power, the associated transmission components can be smaller, lighter, and less expensive than might otherwise be necessary. By coupling both motor/generators to the wheels using a fixed gear ratio, the invention avoids gear shifting, and powertrain smoothness is not compromised.

In general, the invention employs an electric-powered vehicle (e.g., a hybrid vehicle or a full electric vehicle) with a battery and a first electric motor with inverter (i.e., electric drive) connected to the battery and through a fixed gear ratio to the wheels. The motor propels the vehicle and regenerates deceleration energy back to the battery. The system also includes a second electric drive connected to the battery and through a fixed (not necessarily the same) gear ratio to the wheels. It performs the same functions as the first electric drive.

The system includes a control system for controlling the two electric drives. As in conventional systems, the control system defines a requested wheel torque and speed and accordingly commands the electric drive to operate at a specific torque and speed. This novel control system consults a lookup table or a mathematical function to determine a proportion of torque to be provided from each electric drive. The lookup table specifies the optimal ratios of torques for best system efficiency. The control system is thus able to provide the requested torque at the best-possible efficiency, which can be higher than the efficiency of the single motor solution for most operating points.

In some embodiments, the two motors may be connected to the wheels in a speed-summing arrangement, such as with a planetary geartrain. In one speed-summing configuration, one electric motor is connected to the sun gear, and the is other connected to the ring gear while the planet carrier provides the output. Another configuration has one electric motor connected to the sun gear, and the other connected to the planet carrier with the ring gear providing the output. A third configuration has one electric motor connected to the ring gear, and the other connected to the planet carrier with the sun gear as the output. The controller in the speed-summing arrangement calculates the desired speed and torque, then chooses from a lookup table or a function the optimal combinations of motor speeds to give best efficiency at the requested torque.

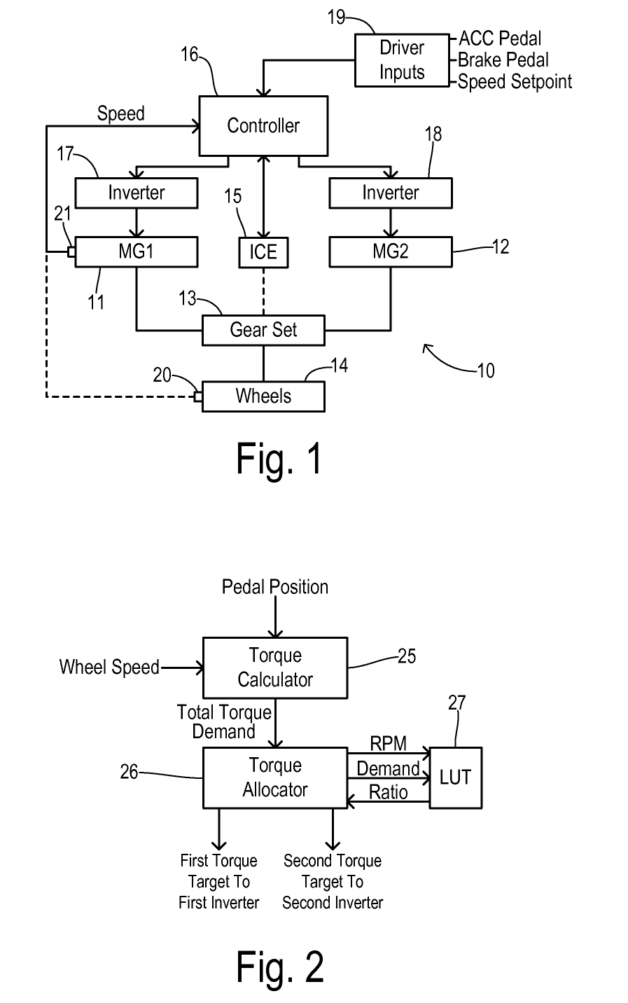

Referring now to FIG. 1, an electric vehicle drive system 10 includes a first motor/generator 11 and a second motor/generator 12 each coupled by a gear set 13 to a set of wheels 14. An internal combustion engine 15 may also be coupled by gear set 13 to wheels 14 in the case of a hybrid vehicle, for example. A split gearset can be employed as known in the art.

A controller 16, such as a powertrain controller (PCM), is coupled to engine 15 and to motor/generators 11 and 12 via respective inverters 17 and 18. Inverters 17 and 18 operate using established methods for supplying electrical power from a main battery (not shown) to drive motor/generators 11 and 12 using current-controlled feedback in order to deliver a desired torque. Controller 16 receives driver inputs 19 such as an accelerator pedal position, brake pedal position, or cruise control speed setpoint in order to determine a demanded wheel torque. A speed sensor 20 associated with wheels 14 and/or a speed sensor 21 associated with motor/generator 11 provide a speed signal to controller 16 for use in the calculations to determine demanded wheel torque as known in the art.

Gear set 13 represents any of several known arrangements for splitting torque between motor/generators 11 and 12 wherein torque produced by motor/generators 11 and 12 are added together for delivery to the wheels. Conversely, during regenerative braking, torque generated at the wheels is divided by gear set 13 between motor/generators 11 and 12 under control of the switching operation of inverters 17 and 18. Gear set 13 may include one or more planetary gear sets, for example. Motor/generator 11 and/or motor/generator 12 may be coupled to a gear set by a one way clutch (OWC).

In one preferred embodiment, motor/generator 11 may be a primary traction drive, while motor/generator 12 functions as a secondary traction drive and also as a sole or primary generator for charging a main battery using power supplied by an internal combustion engine in a hybrid vehicle. In such an arrangement, the primary drive may have a higher maximum torque output than the secondary drive. Moreover, the two motor/generators may have maximum efficiencies that fall at different output torques. These differences between the two drive sources may create improved opportunities for obtaining optimized power-sharing combinations as described below.

FIG. 2 shows a functional block diagram for a control circuit of the present invention. Typically, the functions shown may be implemented within a powertrain controller or main vehicle system controller. A torque calculator 25 receives an accelerator pedal position and a wheel speed to determine a total torque demand. The total torque demand is provided to a torque allocator 26 for determining first and second torque target values for the first and second motors. More specifically, the torque targets would usually be converted to equivalent current levels for controlling the first and second inverters.

In this preferred embodiment, a lookup table 27 is provided for obtaining a ratio to be used for splitting the torque demand into the first and second torque targets. Torque allocator 26 uses rotational speed RPM (e.g., motor rotation or equivalently the wheel speed depending on the calibration used for lookup table 27) and the total torque demand as index values into lookup table 27 in order to retrieve the ratio for splitting the total torque demand between the two motors. For example, the ratio may be specified as a percentage of the total torque to be produced by the second motor/generator. Since the efficiencies of the separate motors typically vary according to voltage and temperature, the lookup table or other means for determining the ratio for splitting the torque can also take voltage and temperature into consideration, if desired.

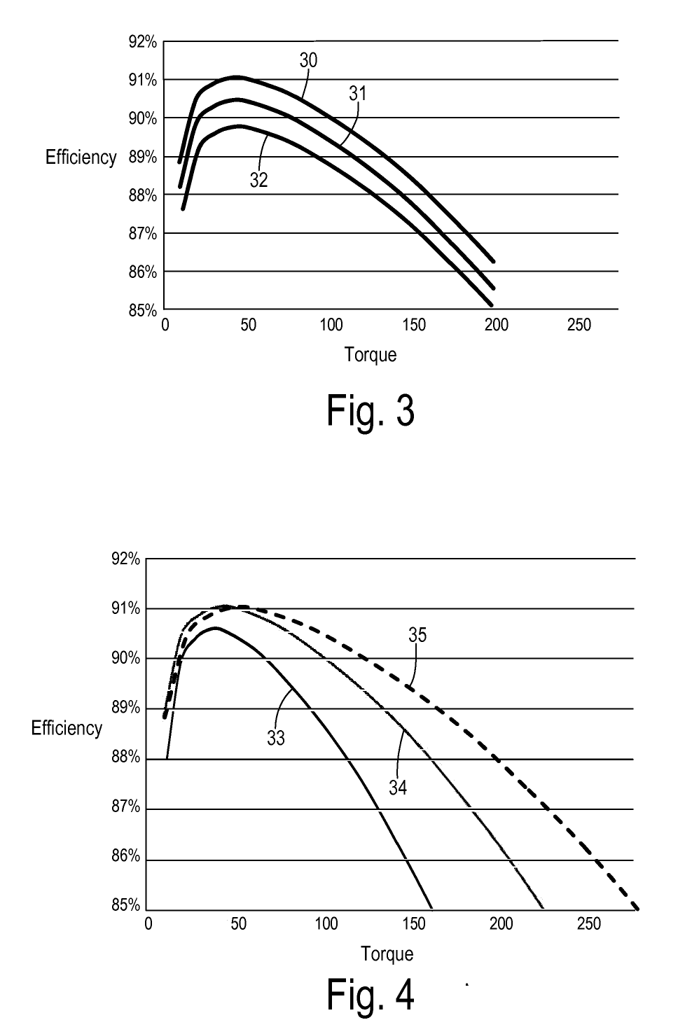

A basis for splitting torque generation between two traction motors will be explained with reference to the graphs in FIGS. 3-6. As shown in FIG. 3, any particular motor has a characteristic efficiency that varies with torque while operating at different corresponding speeds. For simplicity of illustration, efficiency characteristics are shown for a standard voltage and temperature. One skilled in the art can easily extend this system and method to include voltage and/or temperature as additional variables in determining the torque-splitting ratio. Thus, a first efficiency curve 30 shows the efficiency obtained at a first constant rotation speed while the torque production varies. At other rotation speeds, different levels of efficiency may be obtained as shown by curves 31 and 32. When a single traction motor is utilized in an electric vehicle drive, operating points within the normal operating range will inevitably be frequently used which provide less than the peak efficiency. Motor design can attempt to match high levels of efficiency to the prevalent speeds and torques expected during normal usage, but efficiency limitations remain.

FIG. 4 shows efficiency curves 33 and 34 for two different traction motors operating at one particular rotational speed. As torque varies, efficiency for the two motors are characterized by the typical peaks and a fall off of efficiency around the peaks. By combining the outputs of two such motors, however, the relative proportions of torque being produced by the motors can be adjusted to keep each motor operating close to its peak efficiency. Thus, an improved overall efficiency curve 35 can be obtained by dividing the total torque target into first and second torque targets for the respective motors. The relative proportion or ratio for splitting the torque is chosen herein to substantially maximize the combined efficiency.

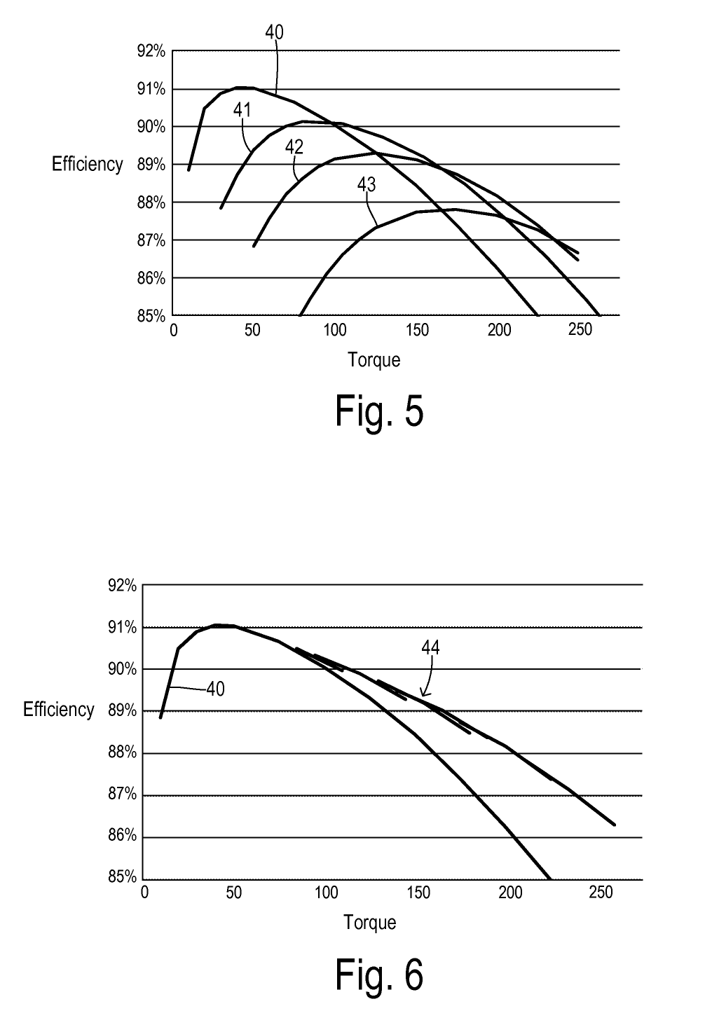

In order to determine a power-sharing ratio that optimizes the combined efficiency, published (or measured) characteristics of the two motors can be used to calculate a combined efficiency over different combinations of speed and torque as follows. As shown in FIG. 5, a family of curves may be created for particular values of the rotation speed and combined torque output, wherein each respective curve corresponds to a fixed torque output for one of the motors. Torques values are given in Newton-meters (N-m). In a first curve 40, the first motor provides 100% of the torque and the second drive provides 0%. In the current example, the torque ratio is expressed as a percentage of the total torque being supplied by the second motor. Thus, the ratio corresponding to curve 40 is 0.0. A curve 41 corresponds to constant torque generation of 20 N-m from the second motor and a variable torque production from the first motor resulting in a combined torque as shown along the x-axis. The resulting combined efficiency of curve 41 crosses curve 40 at a torque of around 100 N-m, and then at higher torques the combined torque production has a higher efficiency than if using the first motor alone. Similarly, curves 42 and 43 correspond to fixed torque contributions of 40 and 60 N-m from the second motor, respectively, results in some operating points with additional improvements in overall efficiency. As shown in FIG. 6, the different relative contributions from the second motor can be pieced together has shown at 44 in order to significantly improve overall efficiency as compared with curve 40. FIGS. 5 and 6 convey the general relationships used to identify torque sharing that obtains optimized efficiency, but the torque ranges for generating a table to be used during actual operation would typically be smaller so that many more curves would be considered.

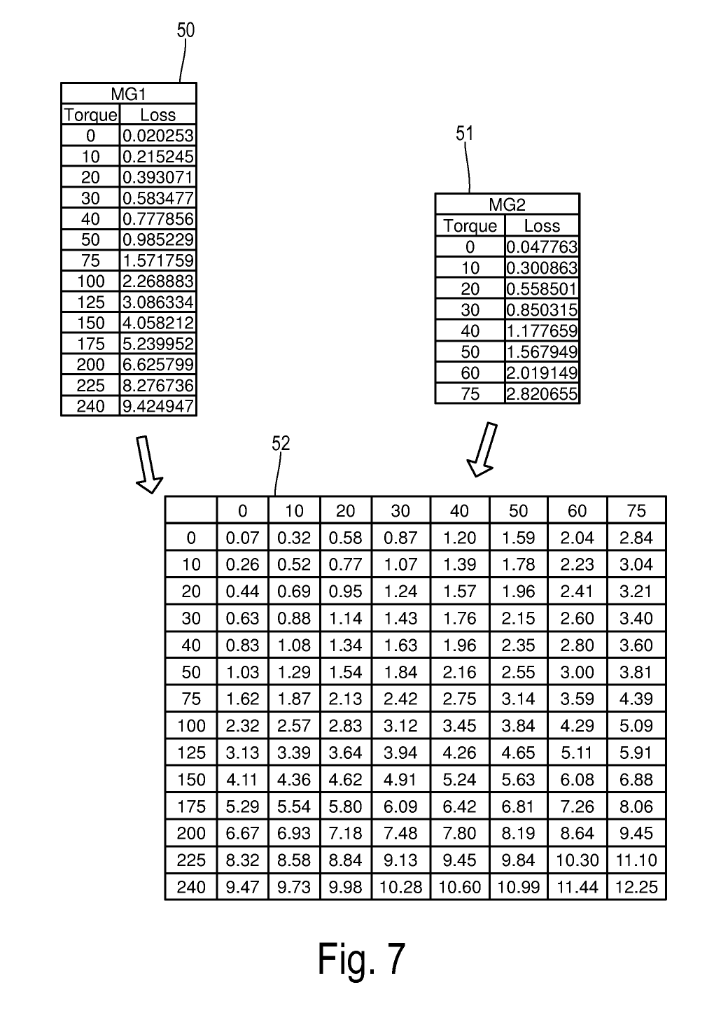

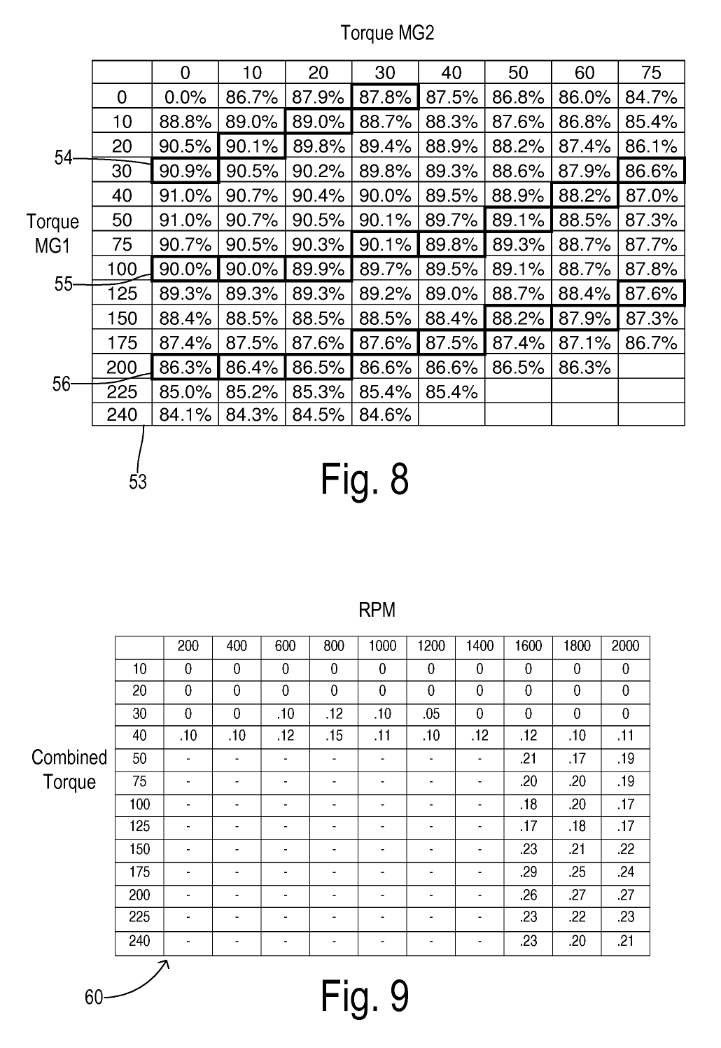

In order to conveniently determine the appropriate values for the ratio for sharing torque production at different rotational speeds, the full spectrum of operating points are preferably broken down into a plurality of respective speed ranges and torque ranges so that a reasonable size is obtained for the lookup table. By analyzing how the losses vary for the two motors at different torque ratios, the optimum ratios can be determined for each combined torque target and speed. As shown in FIG. 7 which depicts performance at one particular rotational speed, a data table 50 containing the overall losses occurring in the first motor generator in various torque generation ranges is combined with a table 51 which similarly represents losses in the second motor generator for respective torque generation ranges, in order to produce a combined-loss table 52. The combined losses shown in FIG. 7 can be converted into efficiency values based on the relationship that efficiency is equal to the total output torque divided by the sum of the total output and the total losses. By applying this relationship, an efficiency table 53 is generated as shown in FIG. 8. As previously noted, table 53 corresponds to one particular rotational speed (i.e., speed range).

For any particular value (or range) of total torque demand, different proportional splits of the torque between the two motors can be utilized. The efficiencies obtained at each of the potential relative contributions (i.e., ratios) can be examined in table 53 in order to identify the contribution ratio which corresponds to the highest overall efficiency. For each total torque demand value, the possible combinations of torque contributions appear as a chain running across table 53. For example, a first chain 54 of highlighted cells in table 53 correspond to a total torque generation of 30 N-m. The highest efficiency in chain 54 occurs with a 90.9% efficiency when the first motor/generator contribution is 30 N-m and the second motor/generator contribution is zero. Thus, the corresponding ratio of torque to be contributed by the second motor/generator under these conditions would be 0.0.

A second chain 55 is highlighted corresponding to a desired total torque production of 100 N-m or more (i.e., up to but not including the next range). The highest efficiency obtainable in chain 55 is 90.1% which occurs with a torque contribution of 30 N-m from the second motor. Thus, when operating at the particular speed range represented by table 53 and the demanded torque is in the range of 100 N-m, then the second motor should produce torque in the 30 N-m torque range. Thus, the ratio for the corresponding range of operating points would be set at 0.3.

A chain 56 in table 53 is shown for a total torque demand corresponding to 200 N-m. The highest efficiency in chain 56 is 88.2% which occurs at a second motor torque contribution of 50 N-m. The ratio for this range of operating points would be 0.25.

By calculating a plurality of efficiency tables for each respective speed range each covering the full range of torque generation, a lookup table can be generated as shown in FIG. 9. Thus, a lookup table 60 includes a plurality of rows corresponding to different total torque ranges and a plurality of columns corresponding to respective motor speed ranges. Lookup table 60 is shown partially filled with some hypothetical values for the ratio to be used for allocating torque between the first and second motors. It should be noted that this example of expressing the relative torque sharing as a ratio defining an amount of torque generation to be derived from one of the motors is just one of many possible ways to calculate a torque allocation. Other equivalent methods for populating a lookup table or defining a mathematical relationship to identify the respective torque targets for the two motors will be occur to those skilled in the art.

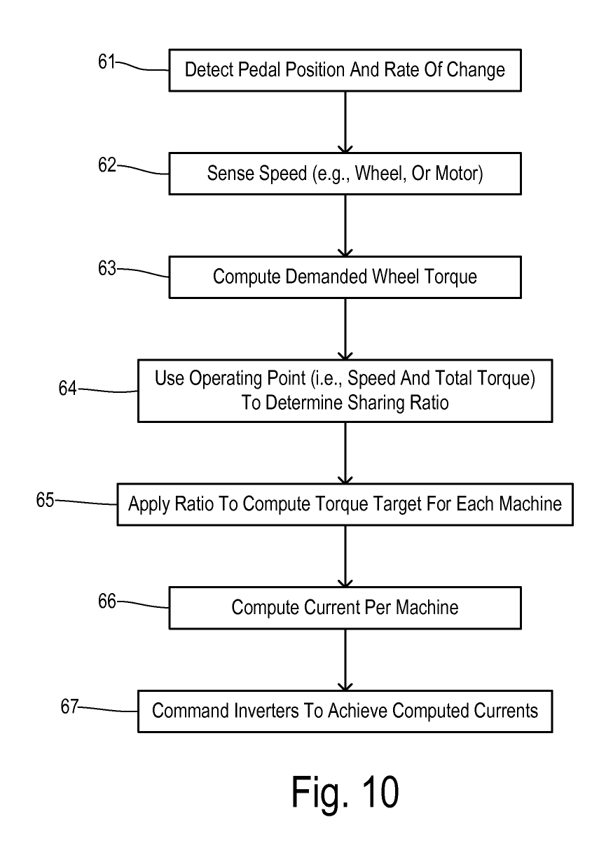

FIG. 10 shows one preferred embodiment of a method for operating a vehicle with an electric drive using first and second traction motors. In step 61, an accelerator pedal position and the rate of change of pedal position are detected. In step 62, the current operating speed is sensed (e.g., as a wheel speed or a motor speed). Based on the pedal information and speed information, a demanded wheel torque is computed in step 63.

In step 64, the operating point comprised of the instantaneous speed and total torque demand is used to determine (e.g., look up) a torque sharing ratio. The ratio is applied in step 65 to compute separate torque targets for each of the two electric machines. Based on the torque targets, the current flows to each machine are computed in step 66, and then the respective inverters are commanded to achieve the computed currents in step 67. As a result, the target torques are delivered by the two electric machines to the wheels such that overall motor efficiency is maximized at the instantaneous rotational speed of the current operating point.

What is claimed is:

1. An electric vehicle drive comprising:
a first motor/generator;
a second motor/generator;
a set of wheels;
a gear set coupling the first and second motor/generators to the set of wheels such that a total wheel torque is selectably divided between the first and second motor/generators;
a torque calculator responsive to an operator speed input to select a total torque target;
a torque allocator substantially maximizing a combined efficiency of the first and second motor/generators by dividing the total torque target into first and second torque targets for the first and second motor/generators according to a ratio is selected in response to an instantaneous motor/generator speed and the total torque target.

2. The electric vehicle drive of claim 1 wherein the torque allocator comprises a lookup table defining respective ratios corresponding to respective combinations of a plurality of speed ranges and a plurality of total torque ranges.

3. The electric vehicle drive of claim 1 further comprising:
a first inverter coupled to the first motor/generator and configured to be controlled to generate the first torque target; and
a second inverter coupled to the second motor/generator and configured to be controlled to generate the second torque target.

4. The electric vehicle drive of claim 1 wherein the first motor/generator is a primary drive having a first maximum torque, and wherein the second motor/generator is a secondary drive having a second maximum torque lower than the first maximum torque.

5. The electric vehicle drive of claim 1 wherein the first motor/generator has a maximum efficiency at a first output torque, and wherein the second motor/generator has a maximum efficiency at a second output torque which is not equal to the first output torque.

6. A vehicle comprising:
first and second traction motors coupled to a gear set to deliver a combined torque from the motor to vehicle wheels;
a powertrain controller receiving user input to determine a demanded torque;
first and second inverters controlling the motors according to first and is second torque targets; and
a torque allocator setting the torque targets in response to the demanded torque and an instantaneous speed of the motors.

7. A method of driving vehicle wheels using first and second traction motors comprising:
sensing a motor rotational speed;
setting a wheel torque demand in response to a driver input;
allocating the torque demand into first and second targets according to a ratio maximizing overall motor efficiency at the rotational speed; and
controlling the first and second traction motors to deliver the first and second targets, respectively.
